(19) United States
(12) Patent Application Publication
(10) Pub. No.: US 2025/0225675 A1
(43) Pub. Date: Jul. 10, 2025

(54) METHOD FOR DETERMINING ITEMS OF OBJECT INFORMATION IN A MEDICAL EXAMINATION AND/OR TREATMENT ARRANGEMENT, MEDICAL EXAMINATION AND/OR TREATMENT ARRANGEMENT, COMPUTER PROGRAM AND ELECTRONICALLY READABLE DATA MEDIUM

(71) Applicant: Siemens Healthineers AG, Forchheim (DE)

(72) Inventors: Verena SCHMIDT, Erbendorf (DE); Andreas DEINLEIN, Bayreuth (DE); Stefan DOLESCHAL, Grafenwoehr (DE); Vladimir JENDROL, Giraltovce (SK)

(73) Assignee: Siemens Healthineers AG, Forchheim (DE)

(21) Appl. No.: 19/008,731

(22) Filed: Jan. 3, 2025

(30) Foreign Application Priority Data
Jan. 4, 2024 (DE) 10 2024 200 072.8

(51) Int. Cl. G06T 7/70

(52) U.S. Cl. CPC G06T 7/70

(57) ABSTRACT

A method for determining items of object information in at least one of a medical examination or treatment arrangement with at least one object is provided. The at least one object is captured via at least one camera and an item of object information includes at least one of identification information or positional information relating to the at least one object. The item of object information is determined via a control device by evaluating camera data from at least one camera image obtained by the at least one camera, and the at least one object is equipped with a tracking device. The method comprises: determining, via the tracking device, an item of pose information describing at least one of a position or an orientation of the at least one object; and using the item of pose information to determine the item of object information.

### CROSS-REFERENCE TO RELATED APPLICATION(S)

The present application claims priority under 35 U.S.C. § 119 to German Patent Application No. 10 2024 200 072.8, filed Jan. 4, 2024, the entire contents of which is incorporated herein by reference.

### FIELD

One or more example embodiments of the present invention relate to a method, in particular a computer-implemented method, for determining items of object information in a medical examination and/or treatment arrangement with at least one object, said object being captured via at least one camera, and an item of object information which comprises an identification of and/or positional information relating to the object being determined via a control device by evaluating at least camera data from at least one camera image made by the camera. One or more example embodiments of the present invention also relate to a medical examination and/or treatment arrangement, a computer program and a non-transitory electronically readable storage medium.

### BACKGROUND

Medical examination and treatment arrangements, in particular the central examination and treatment devices thereof, are becoming increasingly complex and often feature parts or components which can be moved in a controllable manner via suitable actuators. While it is generally possible for such components to be controlled by a user with the aid of operating elements, there is also a trend for certain functions to be given a degree of autonomy in examination and treatment arrangements. In both cases, for greater safety, it is appropriate to identify other objects which might be situated in the path of movement and, particularly when using virtual three-dimensional models of objects, to know their position and orientation and/or their dimensions generally, for example in order to avoid collisions. In real terms, movement paths for at least specific types of objects can be determined in such a way that a collision can be avoided.

One example of a medical technology device that can be equipped with a degree of autonomy is a mobile C-arm of an x-ray device. An x-ray source and an x-ray detector can be arranged opposite each other on the C-arm. The mobile C-arm also comprises a mobile base, for example with a chassis, and can also have further degrees of freedom of movement to which corresponding actuators are assigned. If a user then selects a desired position, for example in the form of a specific recording geometry, a control device of the examination and treatment arrangement, in particular of the x-ray device itself, can, using the available degrees of freedom, determine a movement trajectory in such a way that the mobile C-arm autonomously brings about the desired recording geometry. The same applies to permanently installed C-arms having different types of degrees of freedom of movement as components or parts of medical technology devices.

In another specific example, a degree of autonomy is proposed for patient tables, particularly if it is necessary to arrive at a specific position exactly, for example for the purpose of coupling to an imaging device.

For this and comparable cases, capture of the environment is necessary, in particular with regard to objects which might come into collision. For this purpose, it has been proposed to provide cameras which are situated on the mobile components and/or otherwise directed at the movement region of the mobile components, and which record camera images so that information relating to objects in the movement region can be obtained therefrom at any moment by evaluation. In this case, use is often made of trained evaluation functions, which may comprise, for example, neural networks, in particular CNNs. For example, such evaluation functions are trained to classify objects contained in the camera data from the camera images into object classes, for example “mobile instrument table”, “operating unit”, “infusion stand” and the like. The machine learning in this case is done on the basis of training data which contains various specific embodiments of objects in these object classes. As is generally known, this means that trained evaluation functions provide possible object classes with associated reliability values, in particular probabilities. In addition to the identification of objects, i.e. the assignment of an object class to an object contained in the camera image, it has also already been proposed in a corresponding manner to determine orientations and/or positions, in particular therefore poses, for example relative to the camera and/or a component which is operated at least partly autonomously.

The use of a range of probabilities or comparable reliability values is in principle less desirable, particularly in the case of safety functions. Rather, evaluation results having minimal ambiguity are preferred.

### SUMMARY

An object of one or more embodiments of the present invention is to specify an improved mechanism and/or means, which in particular allows greater reliability and resilience with regard to the results, for determining items of object information relating to at least one object when evaluating camera images.

At least this object is inventively achieved by a method, in particular a computer-implemented method, a medical examination and treatment arrangement, a computer program and a non-transitory electronically readable storage medium according to the other independent claims. Advantageous developments are derived from the subclaims.

According to a method of the type cited in the introduction, provision is inventively made for the object to be equipped at least from time to time with a tracking device, and for an item of pose information describing the position and/or the orientation of the object to be determined via the tracking device, said item of pose information being used, in particular as an aid, for the purpose of determining the item of object information.

It is therefore proposed, for the purpose of recognizing and monitoring the position and the orientation, i.e. the pose, of an object of a medical examination and treatment arrangement, to equip said object with a tracking device. This can be an active self-measuring tracking device or a passive tracking device in the form of a marker which can be understood to be a pose marking device or pose monitoring marker.

When using an active self-measuring tracking device, the item of pose information is preferably determined in the same coordinate system as that used for the camera data. This can be achieved via suitable calibration, for example. When using a pose marking device as a tracking device, camera data relating to the pose marking device is captured when the object is captured in a camera image, and the evaluation of said camera data relating to the pose marking device makes it possible to determine extremely resilient and reliable items of pose information which describe the current position and/or the current orientation of the object.

The tracking device can be installed on the object, but can also be realized as part of the object, in particular as an integrated part.

While the item of pose information can in principle be incorporated directly into the item of object information in order to supplement this with a resiliently and reliably ascertained position and/or orientation of the object, it is preferable in the context of the present invention to use the item of pose information as an aid, in particular with regard to the reliability of the results of further evaluation functions, in particular trained evaluation functions. It has been recognized that at least as long as the evaluation functions, i.e. image processing or image recognition functions, do not satisfy or do not adequately satisfy requirements in respect of safety, said requirements being most relevant in the medical field in particular, a supporting functionality is extremely useful and advantageous in order to meet the preferred requirements. In other words, the resilience and reliability of the evaluation of the camera images in respect of the objects is considerably improved by combining conventional evaluation functions, i.e. image recognition software, with the tracker device, it being possible to use the item of pose information for example for the purpose of improving the reliability values and/or for the purpose of providing a certain redundancy, as explained in greater detail below.

In particular, exemplary embodiments can provide for a reliability value to be determined for the item of pose information also, the use of the item of pose information being then dependent on the reliability value of the item of pose information and/or on a comparison of the reliability value of the item of pose information with a reliability value of the item of object information. It is then possible to introduce for example different probability levels for specific properties of the object, in particular the orientation, and on this basis the control device can decide which entity detected an object, in particular the orientation thereof, correctly, in particular more reliably and/or resiliently.

In real terms, provision can be made for the camera data to be evaluated by a trained evaluation function, which determines at least one object class of the object with an associated item of reliability information, in particular a reliability value, as output data. In this case, the object is therefore identified as belonging to at least one object class.

A trained function generally replicates cognitive functions, which humans associate with other human brains. By training based on training data (machine learning), the trained function can adapt itself to new circumstances and is able to detect and extrapolate patterns.

In general, parameters of a trained function can be adapted via training. In particular, supervised learning, semi-supervised learning, unsupervised learning, reinforcement learning and/or active learning can be used. Representation learning (also known as feature learning) can also be used. In particular, the parameters of the trained function can be iteratively adapted by a plurality of training steps.

A trained function can comprise e.g. a neural network, a support vector machine (SVM), a decision tree and/or a Bayes network, and/or the trained function can be based on k-means clustering, Q-Learning, genetic algorithms and/or rules of assignment. In particular, a neural network can be a deep neural network, a convolutional neural network (CNN) or a deep CNN. Furthermore, the neural network can be an adversarial network, a deep adversarial network and/or a generative adversarial network (GAN).

With regard to the trained evaluation function, this preferably comprises at least one neural network, in particular a CNN. Such embodiments are shown to be particularly advantageous for the evaluation of camera data.

When using a pose marking device as a tracker device, this is preferably embodied in such a way that a corresponding tracking function can detect and analyze the pose marking device in the camera data without the use of artificial intelligence, in order to ascertain the orientation and the position as accurately as possible. By contrast, use is preferably made of machine learning or artificial intelligence for the evaluation function, in particular with regard to the object class. However, cases are also conceivable in which a trained tracking function is used to determine the item of pose information. As mentioned above, reliability values can be assigned to the item of pose information, irrespective of whether the tracking function is trained or not. Actual embodiments of tracking functions are known for example from tracking in the field of virtual reality (VR tracking), where such position marking devices are likewise used. Tracking devices with active sensor technology which transfer the item of pose information wirelessly can also supply reliability values.

When using a trained evaluation function, there are various ways in which the item of pose information can profitably be used. In a first advantageous exemplary embodiment, provision can be made for the trained evaluation function to use at least part of the item of pose information, in particular an orientation of the object, as additional input data. In this case, the input data is therefore supplemented by additional information items which allow more resilient and reliable recognition, in particular identification, of the object. Therefore the tracking device first determines the item of pose information, from which at least the orientation is included as input data in the image recognition that is realized by the trained evaluation function. The trained evaluation function now knows that it must search for an object in a specific pose, which reduces the number of possible objects and improves the matching. This results in an identification of the object with a higher degree of probability.

It is generally the case that when an object (of a specific object class) is detected, it is also useful or even necessary to determine the pose of the object for most of the functions that use the corresponding item of object information. Therefore, as already proposed in the prior art, provision can be made for at least one of the at least one trained evaluation functions also to determine, in addition to the object class, an orientation of the object and/or position of the object (as positional information), which is then compared with the orientation and/or position of the object according to the item of pose information in order to check the plausibility of the evaluation result of all trained evaluation functions. In such an embodiment, it is therefore advantageous that the trained evaluation functions, in particular a single trained evaluation function, can also supply, in addition to the object class, individual information items relating to the pose as output data, in particular with regard to the orientation. The trained evaluation function therefore ascertains an object class with an assigned reliability value and an orientation/orientation class and/or position, i.e. the positional information, in particular including an assigned reliability value. The pose, in particular orientation, that is ascertained via the tracking device can then be used to check whether the detected object according to the trained evaluation function has the same pose as the actual object according to the item of pose information. In this way, image recognition, in particular identification of objects in the camera data, can be achieved with a redundancy which increases the reliability and resilience, since it can be assumed to be improbable that an object and the pose thereof are both detected incorrectly.

The tracking device can appropriately have an identification feature which is assigned to the object that is equipped with the tracking device and by which an item of identification information relating to the object is determined, said item of identification information being used to check the plausibility, in particular additionally check the plausibility, of the object class that has been determined. A tracking device which measures actively and transfers the item of pose information, in particular wirelessly, can for example transfer the item of identification information, which is for example stored in a storage device or storage means of the tracking device, with the item of pose information, this also being useful in particular if a plurality of tracking devices are used, in particular for a plurality of objects. Alternatively or additionally, if the tracking device is designed as a pose marking device, this can also have an external identification feature for the unambiguous identification thereof, said external identification feature being detected in the evaluation of the camera data and used to identify the object. If the tracking devices are permanently assigned to objects, the assignment of the identification feature to the object can be stored in a database of the control device, for example. It is also possible in this context in particular to use generic identification features for object classes and then equip every object of the object class with a tracking device which has the identification feature for the object class, such that the item of identification information describes an object class of the object in this case. The object is thus identified as an object of the object class, as occurs likewise in a corresponding embodiment of the trained evaluation function.

In other words, via an unambiguous identification feature of the tracking device and mapping between said identification feature, it is possible additionally to determine an object, in particular an object class, independently of the camera data, and therefore the combination of the identification feature of the tracking device and the image evaluation of the camera data produces a further redundancy which can increase the resilience and reliability of the evaluation. This provides an immediate (i.e. true) redundancy in respect of the identification of the object.

With regard to the plausibility checking/redundancy in relation to both the item of pose information and the item of identification information, appropriate developments of embodiments of the present invention can provide for the reliability value to be adapted as a function of the at least one plausibility check result. In this case, the redundancy is therefore fully utilized in order to rate the resilience and reliability again, in particular to specify higher reliability values for the final result if there is agreement or at least substantial agreement. However, if the redundancy gives rise to differing results, the plausibility check result then indicates a failed plausibility check, and special measures can be prescribed. In the event of at least one plausibility check failing, in particular if an implausibility condition is met, provision can thus be made for at least one assigned measure to be carried out, in particular an indication to a user and/or a modification of the item of object information and/or of a utility function which uses the item of object information. A user can therefore be warned that an inaccurate/failed detection of objects has possibly occurred, so that said user can personally take over the control of a medical technology component which uses the item of object information in a utility function. It is naturally also possible to reflect this in the item of object information by modification thereof. For example, and particularly in the case of safety-critical utility functions, provision can be made to change the item of object information to an object or the object to which the highest safety standards are applied. An adaptation can also take place in the utility function, in that this selects higher safety standards for the object that was not reliably detected. Such an adaptation can also be achieved implicitly, by lowering the reliability values if an implausibility condition is met.

In a specific example, in the case of at least partly autonomous movement of a component by the utility function, a decision which governs how certain object classes are treated may already exist. This means that for many object classes, for example owing to their assumed resilience against impacts, a significantly smaller safety margin may be envisaged than in the case of other object classes which could be damaged, for example, and which in turn may require less of a safety margin than object classes relating to people. For example, in the case of a failed plausibility check, where in particular the implausibility condition is therefore met (which condition, generally speaking, can compare for example a difference between the tracking results and the results of the evaluation function with a threshold value), larger safety margins can be selected, etc., possibly also on the basis of a reduced reliability value.

In a particularly appropriate development of the present invention, provision can be made for the item of pose information and/or the item of identification information to be stored together with the assigned camera data as a training dataset, in which the item of pose information and/or the item of identification information defines the fundamental truth, and used for the purpose of training at least one of the at least one trained evaluation functions. If the item of pose information and/or the item of identification information is not sufficient to adequately define the fundamental truth, and particularly if an item of identification information relating to the object is not present, provision can be made for the training dataset to be supplemented in respect of the fundamental truth by at least one information item that is provided by a user. In such an embodiment, particularly if the item of identification information is determined and therefore the fundamental truth can be ascertained entirely automatically, it is conceivable on one hand to record such training datasets during the actual use of the examination and/or treatment arrangement and to use them for further improvement of the trained evaluation function. It is however also possible to use the tracking devices in a training phase, and if applicable only in the training phase of the machine learning, specifically for the annotation of camera data here. In both cases, a clear improvement of the trained evaluation function is achieved, and therefore an improvement in the quality of the results thereof, i.e. the item of object information.

As mentioned above, provision can be made generally for the tracking device to be designed as a pose marking device, the item of pose information being determined from camera data relating to the pose marking device during the evaluation. In this case, the pose marking device is appropriately attached to or arranged on the object in such a way that at least one reference direction of the pose marking device, this reference direction being unambiguously identifiable by the evaluation, corresponds to a distinct object direction of the object, an item of assignment information that describes said correspondence being stored in the control device for use during the evaluation. In this way, a registration is ultimately produced between the pose marking device (and therefore a coordinate system of the object) and the control device with the corresponding evaluation unit, and corresponding information items can be compared. It is possible in this case to specify for example guidelines indicating how pose marking devices must be attached to respective objects of given object classes, said guidelines forming the basis of the item of assignment information.

It is correspondingly appropriate, in the case of a tracking device which measures actively, for the tracking device and the camera to be registered with each other and/or calibrated with a coordinate system that can be used by both. In order to achieve this, for example a calibration process can take place using a shared calibration object. Since the camera and the object, and hence the tracking device, move relative to each other, it is appropriate to refer to a coordinate system that can be shared and is in particular fixed, for example a static coordinate system of the examination and/or treatment arrangement and/or a medical technology device thereof, for example an imaging device. If the camera is mobile, position-finding device, mechanism or means preferably exist on the component bearing the camera, for the purpose of determining the position of the component (and hence the camera) in the static coordinate system. With regard to the object, monitoring of the respective position and orientation is already provided by the tracking device.

In a specific embodiment, provision can be made for the camera and the control device to form part of a control system for a medical technology device that is to be operated at least partly autonomously, the item of object information being used to determine at least one control measure for the medical technology device. For example, an imaging device component which can be moved in a controlled manner, in particular a mobile C-arm and/or a mobile patient table, can be used as the medical technology device. In this type of configuration, at least one of the at least one cameras can be provided on the component itself and/or at least one of the at least one cameras can be external to the component, in particular static, and directed at an operating region of the component. For example, the utility function can be a guidance function for at least partly autonomous movement of the component, it being possible for items of object information to describe obstacles that must be considered. For example, the utility function can use the items of object information for the purpose of determining trajectories for the component or an element of the component. In this context, for example, as mentioned above, different safety specifications (safety standards) can be used for different object classes, for example different safety margins, which can be larger for people than for sensitive objects, while smaller safety margins can in turn be chosen for less sensitive objects.

In addition to the cited examples, the medical technology devices or components can however be otherwise selected. In particular, embodiments of the present invention can be applied to any object that can be moved in a controlled manner, such as robots, auxiliary devices, etc.

With regard to the tracking device, the prior art already proposes a multiplicity of options which can also be used in the context of embodiments of the present invention. In particular, tracking devices from the field of “virtual reality tracking” (VR tracking) can be used, i.e. at least one VR tracking device.

If the tracking device comprises or is a pose marking device, provision can be made for the pose marking device to mark the pose, in particular the orientation, with the aid of a shape of at least one marking body of the pose marking device and/or with the aid of a marking pattern. A multiplicity of systems suitable for this purpose are disclosed in the prior art (optical tracking, i.e. optical monitoring), including in particular those which use components and elements that are already available on the object, and therefore allow an embodiment which is at least partly integrated. If the object has for example a plate, rod or the like which defines the orientation thereof, this can have marking patterns which are readily optically recognizable and can easily be recognized in the camera data. A special layout can also be used both for pose marking devices that can be attached to the object and for integrated pose marking devices.

With regard to a tracking device which measures actively, this may use wireless monitoring, inertial monitoring, acoustic monitoring, magnetic monitoring and other monitoring methods. In particular, the tracking device can have suitable sensor technology, for example receivers for wireless monitoring signals, an inertial platform, transducers, magnetic field sensors and/or the like. It is also possible in principle to deploy tracking devices that use optical tracking.

In addition to the method, embodiments of the present invention also relate to a medical examination and/or treatment arrangement, with at least one object, at least one camera for capturing the object, and a control device which has an evaluation unit for determining an item of object information, this comprising an item of identification and/or positional information relating to the object, by evaluating camera data from at least one camera image made by the camera, said object being equipped with a tracking device and it being possible via the tracking device to determine an item of pose information which describes the position and/or the orientation of the object, said evaluation unit being designed to use the item of pose information for the purpose of determining the item of object information. In other words, the control device is designed to execute the inventive method. All explanations relating to the inventive method can be transferred analogously to the inventive examination and treatment arrangement and vice versa, by virtue of which the previously cited advantages can therefore be achieved in the same way.

In particular, if the tracking device is embodied as or comprises a pose marking device, provision can be made for the evaluation unit to be designed to determine, from the camera data relating to the pose marking device, the item of pose information which describes the position and/or the orientation of the object, and to use the item of pose information, in particular as an aid, for the purpose of determining the item of object information.

The examination and treatment arrangement can be for example an angiography arrangement with a C-arm x-ray device whose mobile C-arm is designed as a component which can be moved at least partly autonomously and for which the control device and the tracking device form part of a control system. In addition to a mobile C-arm as a medical technology device, which can be controlled at least partly autonomously, a patient table can also be such a medical technology device or component thereof.

In particular, the control device has at least one processor and at least one storage device or storage means. Function units for performing steps of a method according to embodiments of the present invention, for example the previously mentioned evaluation unit, can take the form of hardware and/or software. Further function units can include for example a plausibility checking unit, a training unit, a calibration unit and/or a utility function unit for executing a utility function which uses the item of object information. In the case of a tracking device which measures actively, provision is preferably made for wireless communication devices or wireless communication means in order to transfer the item of pose information from the tracking device to the control device.

As mentioned above, the at least one object can be for example an instrument table, an operating unit, a motor unit, an infusion stand, an assistant, a patient, a patient support device, for example a patient table, and/or the like.

A computer program according to embodiments of the present invention can be loaded directly into a storage device or storage means of a control device and has a program or program means whereby execution of the computer program on the control device causes said control device to perform the steps of a method according to the present invention. The computer program can be stored on a non-transitory electronically readable storage or data medium according to embodiments of the present invention such that the data medium therefore contains stored control information which comprises at least a computer program according to embodiments of the present invention and is embodied in such a way that when the data medium is used in a control device of an examination and treatment arrangement, this is designed to perform a method according to embodiments of the present invention. The data medium is in particular a non-transient or non-transitory data medium, for example a CD-ROM.

### BRIEF DESCRIPTION OF THE DRAWINGS

Further advantages and details of the present invention are derived from the exemplary embodiments described below and with reference to the drawings, in which:

FIG. 1 schematically shows an examination and treatment arrangement according to an embodiment of the present invention,

FIG. 2 shows an exemplary object with a tracking device,

FIG. 3 shows a flow diagram of an embodiment of the method according to the present invention,

FIG. 4 shows an explanatory illustration of a first utilization of the item of pose information, and

FIG. 5 shows an explanatory illustration of a second utilization of the item of pose information.

### DETAILED DESCRIPTION

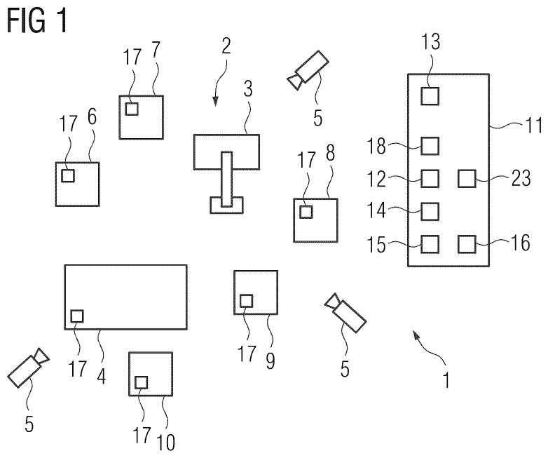

FIG. 1 shows a schematic diagram of an examination and treatment arrangement 1 according to an embodiment of the present invention. The examination and treatment arrangement 1 in the present example is an angiography arrangement which comprises an imaging device 2, specifically a C-arm x-ray device, with a mobile C-arm 3. The mobile C-arm 3 is a medical technology device or component which can be controlled at least partly autonomously and has actuators that can be driven, such as for example a chassis and a rotary actuator system for the C-arm. The mobile C-arm 3 is therefore able to bring about specific recording geometries for a patient on a patient table 4 automatically and autonomously, for example.

In order to provide the knowledge about its environment that is required for the at least partly autonomous movement of the mobile C-arm 3, the examination and treatment arrangement 1 has a plurality of cameras 5 which capture the operating region of the mobile C-arm 3 and consequently also objects 6, 7, 8, 9 and 10 that are arranged within said operating region, including the patient table 4. In this type of configuration, at least some of the cameras 5 can also be integrated in the mobile C-arm 3, the patient table 4 and/or the objects 6 to 10, and/or arranged thereon.

This applies likewise to the schematically shown control device 11, at least some of whose components can also be arranged in or on the mobile C-arm 3, the patient table 4, the cameras 5 and/or objects 6 to 10.

It should be noted at this point that the mobile C-arm 3 is cited merely by way of example as a component that can be controlled at least partly autonomously, and the following explanations can obviously be applied likewise to other such components and/or medical technology devices, for example the patient table 4, a treatment robot, an auxiliary device and the like.

The control device 11 has, in addition to the storage device or storage means 13, an evaluation unit 12 which evaluates the camera data from at least one camera image made by the cameras 5, in order to determine items of object information relating to the objects 6 to 10 and the patient table 4. The items of object information describe both an object class of the respective object 6 to 10 or patient table 4 and the pose thereof, i.e. position and orientation, as positional information. They can also include further information items, for example the extent, though it is also possible to use virtual models which can describe the extent for the various object classes. With regard to the at least partly autonomous control of the mobile C-arm 3, the object classes are also assigned various safety requirements, for example different safety margins. For example, safety margins relating to people as objects, for example the patient, personnel or visitors, are significantly larger than those relating to more resilient objects, for example solid instrument tables.

The items of object information are used in a utility function unit 14 in order to determine a movement trajectory which satisfies the safety requirements and can then be implemented by a control unit 15 accordingly.

In the present exemplary embodiment, the evaluation unit 12 uses a trained evaluation function to evaluate the camera data for the purpose of determining the items of object information. The trained evaluation function can comprise for example a neural network, for example a CNN. In order to train this, the control device 11 can optionally also comprise a training unit 16. In particular, as described in greater detail below, training datasets that have been determined in the examination and treatment arrangement 1 itself can be used within this training unit 16 in order to train the trained evaluation function, in particular for the improvement thereof.

For autonomous control processes, in particular in the context of medical technology applications, a high degree of reliability and resilience of the environment analysis with regard to objects 6 to 10 and patient table 4 is important. In order to achieve improvements here, the objects 6 to 10 and the patient table 4 here are all equipped with a tracking device 17, which can be attached to and/or integrated in the corresponding object 4, 6 to 10. Via the tracking devices 17, the pose of the corresponding assigned object 6 to 10 and patient table 4 can be reliably ascertained and taken into account when determining the item of object information.

In this case, the tracking devices 17 can be tracking devices 17 which measure actively and which transfer, in particular wirelessly, the items of pose information as measured in particular by a sensory device or sensory means to the control device 11, for which purpose a corresponding communication device or communication means 18 is shown at the control device 11. For the sake of clarity, an associated communication device of the tracking devices 17 are not shown. Additionally or alternatively, the tracking devices 17 can however also be pose marking devices which are optically captured by the cameras 5, so that the evaluation unit 12 can determine the item of pose information by evaluating the camera data that shows the pose marking device. Although not shown in FIG. 1, the mobile C-arm 3 itself can obviously also have a tracking device 17.

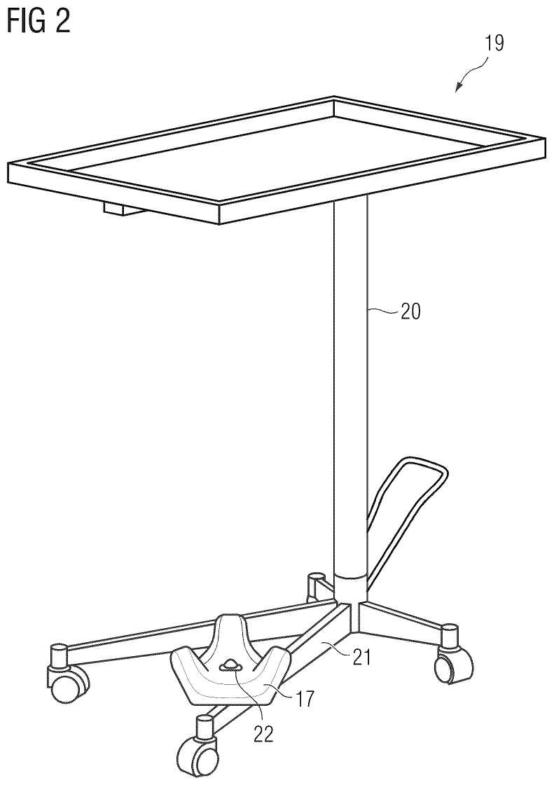

By way of example, FIG. 2 shows tracking device 17 for an object 19, here an instrument table 20, said tracking device 17 being arranged in a defined manner on a rolling frame 21, such that object directions of the object 19 can be clearly assigned to the items of pose information, i.e. reference directions of the tracking device 17, for which purpose a corresponding item of assignment information can be stored in the control device 11 in an embodiment as a pose marking device. In the case of measuring tracking devices 17 which measure actively, a registration between the control device 11, in particular a coordinate system in which the camera data from the cameras 5 is evaluated, and the tracking device 17 can be achieved via, for example, a calibration process, for which purpose the control device 11 can have a calibration unit (not shown here). A static coordinate system can be used effectively here.

As merely suggested in FIG. 2, the tracking device 17 can have an identification feature 22 which can be recognized electronically, or optically by the cameras 5 in the case of an embodiment as a pose marking device, and which can be unambiguously assigned to the object 19 or at least to the object class thereof. In the case of a tracking device 17 which measures actively, the identification feature 22 can be transmitted with the item of pose information via the communication device 18, this being suitable in any case for the purpose of identifying the respective sender from among the plurality of tracking devices 17. In the case of a pose marking device, the identification feature 22 can be recognized by the evaluation unit 12. Via the identification feature, it is possible to determine an item of identification information which is assigned to the item of pose information and relates to the respective object 6 to 10, 19, patient table 4, and which can contain at least the object class and can likewise be used advantageously when determining the item of object information.

In addition to the instrument table 20 and the patient table 4, other objects 6 to 10 are also conceivable. Therefore the object 6 can be for example an infusion stand, the object 7 can be for example a treatment robot, the object 8 can be for example a person providing treatment, the object 9 can be for example an operating unit and the object 10 can be for example a monitor unit.

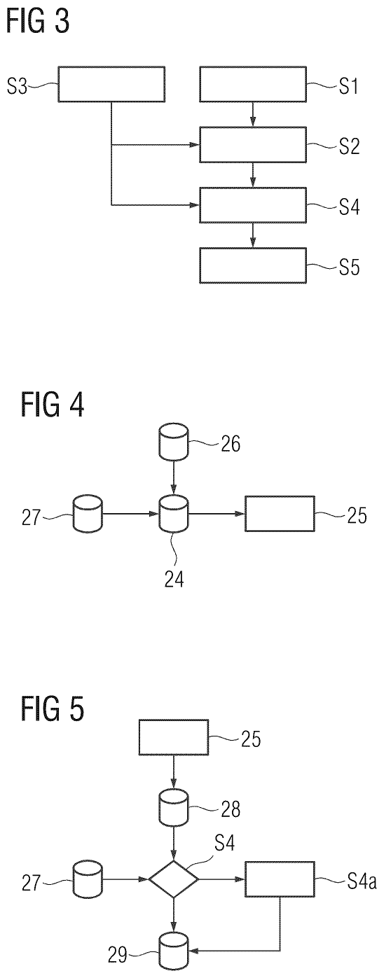

FIG. 3 shows a general flow diagram for an exemplary embodiment of the method according to an embodiment of the present invention. In a step SI here, camera data relating to the objects 6 to 10, 19, patient table 4 is recorded in order to determine in a step S2, via the trained evaluation function in the evaluation unit 12, an object class (as identification of the object 6 to 10, 19, patient table 4), and a position and orientation of the object 6 to 10, 19, patient table 4 as positional information, with assigned reliability values in each case. The item of pose information (and the item of identification information if applicable) determined in a step S3 can already be deployed appropriately here. The item of pose information is also used in a plausibility checking step S4, before the final item of object information (containing at least object class (identification) and pose (positional information)) is forwarded to the utility function in the step S5, where it is used by the utility function unit 14.

The plausibility checking step S4 can be performed in the control device 11 via a plausibility checking unit 23 and is explained in greater detail below.

FIG. 4 shows how the item of pose information can already be used at an early stage to supplement the input data 24 for the trained evaluation function 25. Specifically, not only the camera data 26 is provided there as input data 24 for the trained evaluation function 25, but also the item of pose information, which tells the evaluation function 25 where and in what orientation an object 6 to 10, 19, patient table 4 is expected, thereby simplifying and improving the detection.

As shown in FIG. 5, the trained evaluation function 25 provides output data 28 which, as mentioned above, comprises the object class (with assigned reliability value) as well as a position and orientation, i.e. an actual pose, as positional information, again with assigned reliability value. In the plausibility checking step S4, a comparison is then made between the pose according to the item of pose information 27 and the pose according to the positional information in the output data 28 for the purpose of plausibility checking, and optionally a comparison between the item of identification information and the object class, likewise for the purpose of plausibility checking. If an implausibility condition indicates that the plausibility check has failed, at least one measure is carried out in a step S4a, said measure being in this case the output of a warning signal to an operator who will possibly want to take over the control personally, and an adaptation of the item of object information 29 that is ultimately output, this comprising at least the (possibly adapted) object class and the (possibly adapted) positional information, for example by assigning an object class with higher safety requirements to the possibly erroneously identified object 6 to 10, 19, patient table 4 in order to increase the safety. A measure can also have an effect on the utility function and/or reduce reliability values. If the implausibility condition is not satisfied, i.e. plausibility is established, the reliability value assigned to the object class and the positional information is increased, since this indicates a greater reliability of this item of object information 29.

In addition or as an alternative to the plausibility checking via comparison as described here, the redundancy in respect of at least the pose can also be used in another way, for example in a combination, for which purpose the item of pose information 27 can also be assigned a reliability value. The result can then be selected in relation to the reliability values, for example.

It is finally also possible, in particular when ascertaining an item of identification information, with the aid of the item of pose information 27 (and the item of identification information) to compile training datasets for the training of the trained evaluation function 25, for example via the training unit 16. In this context, a reliable fundamental truth is provided by the item of pose information and the item of identification information. In particular, it is therefore conceivable to use the tracking devices 17 only from time to time in order to determine reliable training datasets and consequently to improve the quality of the output data 28 of the trained evaluation function 25 in such a way that that the redundancy is no longer required (or at least not for every object class).

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention is illustrated and described in detail with reference to the one or more preferred exemplary embodiments, the present invention is not restricted to the examples disclosed herein and other variations may be derived therefrom by a person skilled in the art without departing from the scope of the present invention.

What is claimed is:

1. A method for determining items of object information in at least one of a medical examination or treatment arrangement with at least one object, wherein the at least one object is captured via at least one camera and an item of object information includes at least one of identification information or positional information relating to the at least one object, wherein the item of object information is determined via a control device by evaluating camera data from at least one camera image obtained by the at least one camera, wherein the at least one object is equipped with a tracking device, and wherein the method comprises:
determining, via the tracking device, an item of pose information describing at least one of a position or an orientation of the at least one object; and
using the item of pose information to determine the item of object information.

2. The method as claimed in claim 1, wherein a trained evaluation function is used for evaluating the camera data and determines at least one object class of the at least one object with an associated item of reliability information as output data.

3. The method as claimed in claim 2, wherein the trained evaluation function uses at least part of the item of pose information as additional input data.

4. The method as claimed in claim 2, wherein, in addition to the at least one object class, at least one of an orientation of the at least one object or a position of the at least one object is also determined, via the trained evaluation function, as positional information which is then compared with the at least one of the orientation of the at least one object or the position of the at least one object described by the item of pose information for checking a plausibility of an evaluation result of the trained evaluation function.

5. The method as claimed in claim 2, wherein the tracking device has an identification feature which is assigned to the at least one object and by which an item of identification information relating to the at least one object is determined, the item of identification information being used to check a plausibility of the at least one object class that has been determined.

6. The method as claimed in claim 4, wherein
the reliability information is adapted as a function of at least one plausibility check result, or
in the event that at least one plausibility check fails, at least one assigned measure is carried out.

7. The method as claimed in claim 3, wherein at least one of the item of pose information or the item of identification information is stored together with assigned camera data as a training dataset, and wherein the at least one of the item of pose information or the item of identification information defines a fundamental truth and is used for training at least the trained evaluation function.

8. The method as claimed in claim 7, wherein if an item of identification information relating to the at least one object is not present, the training dataset is supplemented in respect of the fundamental truth by at least one information item that is provided by a user.

9. The method as claimed in claim 1, wherein the tracking device is a pose marking device, and wherein the item of pose information is determined from camera data relating to the pose marking device during the evaluating of the camera data.

10. The method as claimed in claim 9, wherein the pose marking device is attached to or arranged on the at least one object such that at least one reference direction of the pose marking device corresponds to a distinct object direction of the at least one object, wherein said at least one reference direction is unambiguously identifiable by the evaluating, and wherein an item of assignment information describing the correspondence is stored in the control device for use during the evaluating.

11. The method as claimed in claim 1, wherein in case of a tracking device which measures actively, the tracking device and the at least one camera are at least one of registered with each other or calibrated with a coordinate system usable by both.

12. The method as claimed in claim 1, wherein the at least one camera and the control device form part of a control system of a medical technology device that is operable at least partly autonomously, and wherein the item of object information is used to determine at least one control measure for the medical technology device.

13. An arrangement comprising:
at least one object;
at least one camera configured to capture the at least one object; and
a control device including an evaluation unit configured to determine an item of object information by evaluating camera data from at least one camera image obtained by the at least one camera, wherein
the item of object information includes at least one of an item of identification or an item of positional information relating to the at least one object,
the at least one object is equipped with a tracking device and an item of pose information which at least one of describes a position or based on which orientation of the at least one object is determined via the tracking device, and
the evaluation unit is configured to use the item of pose information for determining the item of object information.

14. A non-transitory computer-readable storage medium storing computer-readable instructions that, when executed at a control device of at least one of a medical examination or treatment arrangement, cause the at least one of the medical examination or treatment arrangement to perform the method of claim 1.

15. The method of claim 6, wherein the at least one assigned measure includes at least one of an indication to a user or a modification of at least one of the item of object information or of a utility function which uses the item of object information.

16. The method as claimed in claim 4, wherein the tracking device has an identification feature, which is assigned to the at least one object and by which an item of identification information relating to the at least one object is determined, the item of identification information being used to check a plausibility of the at least one object class that has been determined.

17. The method as claimed in claim 5, wherein
the reliability information is adapted as a function of at least one plausibility check result, or
in the event that at least one plausibility check fails, at least one assigned measure is carried out.

18. The method as claimed in claim 5, wherein at least one of the item of pose information or the item of identification information is stored together with assigned camera data as a training dataset, and wherein the at least one of the item of pose information or the item of identification information defines a fundamental truth, and is used for training the trained evaluation function.

19. The method as claimed in claim 5, wherein in case of a tracking device which measures actively, the tracking device and the at least one camera are at least one of registered with each other or calibrated with a coordinate system usable by both.

20. The method as claimed in claim 5, wherein the at least one camera and the control device form part of a control system of a medical technology device that is operable at least partly autonomously, and wherein the item of object information is used to determine at least one control measure for the medical technology device.
